(19) United States
(12) Patent Application Publication
(10) Pub. No.: US 2008/0251275 A1
(43) Pub. Date: Oct. 16, 2008

(54) Decoupling Transmission Line

(76) Inventor: Ralph Morrison, Pacifica, CA (US)

Correspondence Address: COURTNEY STANIFORD & GREGORY LLP, P.O. BOX 9686, SAN JOSE, CA, 95157, US

(21) Appl. No.: 12/047,224

(22) Filed: Mar. 12, 2008

Related U.S. Application Data
(60) Provisional application No. 60/911,336, filed on Apr. 12, 2007.

(51) Int. Cl. H01B 7/00; H01B 5/00

(52) U.S. Cl. 174/113 R; 174/126.1

(57) ABSTRACT

Devices and methods are described for storing and dispensing electrical energy. A device comprises first and second electrical conductors. An insulator separates the first and second electrical conductors. The first and second electrical conductors can be formed in a folded, linear, stacked, coiled, or coaxial configuration relative to each other. The device includes a first connector that connects the first and second electrical conductors to an electrical source, and a second connector that connects the first and second electrical conductors to an electrical load. The device stores and dispenses electrical energy, and a voltage across the electrical load is held substantially constant when the device stores the electrical energy and the electrical load is a resistive load.

### RELATED APPLICATION

This application claims the benefit of United States patent application Ser. No. 60/911,336, filed Apr. 12, 2007.

### TECHNICAL FIELD

The disclosure herein relates generally to electronic logic structures, including circuit components, circuit boards, and devices from semiconductor dies such as microprocessors, to embedded and surface mounted decoupling capacitors, for example.

### BACKGROUND

Many conventional electronic systems involve digital logic. A logic system is a group of interconnected logic components. These components are generally mounted on a multilayer circuit board and interconnected using copper traces. These traces are typically routed over or between conducting planes. In fast logic operations, these traces are best treated as short transmission lines. Logic signals are ideally step voltages. When these step voltages are applied to a transmission line, the initial current that flows is determined by the characteristic impedance of the line. Typically, the impedance of a single trace over a conducting plane is 50 ohms.

Most conventional logic systems operate using clocked logic. Logic components often place signal voltages on many traces in parallel. If the power supply voltage is 5 volts (V), then a step voltage applied to ten parallel lines requires a current level of 1 ampere. This high current is usually drawn from a nearby capacitor that is placed across the power supply line. If a capacitor is not present or is not fast enough, the power supply voltage will drop or sag. This drop in voltage generally causes logic malfunctions, crosstalk problems and radiation. This nearby capacitor is called a decoupling capacitor.

As logic speeds have increased, the importance of these decoupling capacitors has increased. Capacitors have their limitations. The accepted lore relates the parasitic inductance of the capacitor to a delay in obtaining energy from the capacitor. Using several capacitors in parallel has been an improvement. Embedding these capacitors in the structure surrounding the die has also been helpful. Several capacitor geometries that provide better performance are covered by existing patents.

Logic clock rates are rising into the gigahertz (GHz) realm. At these high clock rates, the rise and fall times for logic transitions should be less than 100 picoseconds (ps), where a picosecond is 10⁻¹² seconds. Because light travels at 0.03 cm per picosecond, stored energy to drive transmission lines should be available very close to the logic it supports.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a folded transmission line capacitor, under an embodiment.

FIG. 2 shows top and side views of a folded transmission line on a die layer, under an embodiment.

FIG. 3A is a diagram of coaxial decoupling on a mounting structure for a die, under an embodiment.

FIG. 3B is a cross sectional view of a coax used for coaxial decoupling on a mounting structure for a die, under an embodiment.

FIG. 4 is a plot of load voltage versus time for cascaded transmission lines, under an embodiment.

### DETAILED DESCRIPTION

Devices and methods are described below for storing and dispensing electrical energy. A device of an embodiment comprises a first electrical conductor and a second electrical conductor. An insulator separates the first electrical conductor from the second electrical conductor. The first and second electrical conductors can be formed in one of a folded, linear, stacked, coiled, and coaxial configuration relative to each other. The first and second electrical conductors can comprise an integral portion of an integrated circuit die. Furthermore, the first and second electrical conductors as well as the insulator can comprise semiconductor material.

The device includes a first connector that connects the first and second electrical conductors to an electrical energy source. The device further includes a second connector that connects the first and second electrical conductors to an electrical load. The electrical energy source can include one or more of a power supply, a charged circuit capacitor, and a voltage between ground and power planes on a printed circuit board, for example. The electrical load can include one or more of an integrated circuit, a circuit trace on a circuit board, and a transmission line, to name a few. The device stores and dispenses electrical energy, and a voltage across the electrical load is held substantially constant when the device stores the electrical energy and the electrical load is a resistive load.

In the following description, numerous specific details are introduced to provide a thorough understanding of, and enabling description for, embodiments of the device. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

In circuit theory, there is no limit to the amount of power that can be transported over a pair of conductors. This view fails however when using very fast logic, where the power that can be transported over a section of 50-ohm line in the first picoseconds is limited to the characteristic impedance of that line. At 5 V and 50 ohms, for example, the initial maximum transmitted power level is one-fifth watt, which is only 0.1 amperes. Because it is not uncommon for the current demand to be greater than 1 ampere, the characteristic impedance of the voltage source must be much lower than 50 ohms. If the voltage is to drop less that 5%, the characteristic impedance of leads associated with power flow must be less than 0.2 ohms.

Transmission line theory predicts how current develops when a short circuit is applied to an ideal transmission line connected to a voltage source. The current rises in steps as a wave travels back and forth between the source and the short. In a similar manner, if a 5-ohm load is applied to a 50-ohm line there are multiple reflections and the current rises in a staircase fashion. It may take 20 round trips for the current to rise to 95% of its final value. If the line is 0.3 cm long then one round trip takes 20 ps. Twenty round trips takes 200 ps and this is generally too long to operate logic at 1 GHz.

In circuit theory, elements can be in series in any order. In transmission lines the order defines performance. Consider a 0.5 ohm line segment in series with a 50 ohm line segment in series with a 5 volt source. When a 5 ohm load is switched onto the 0.5 ohm end of the line, the voltage drops about 10%. If the line segments are reversed, the voltage drops approximately 90%.

An analysis of transmission lines and energy flow follows in support of the embodiments described herein. Consider two transmission lines in series, referred to herein as line section 1 and line section 2. Transmission line section 1 has a length l₁, characteristic impedance Z₁ and dielectric constant ε₁. Transmission line 2 has a length l₂, characteristic impedance Z₂, and dielectric constant ε₂. Following is a diagram illustrating transmission lines 1 and 2, including a supply voltage, load, switch, and the 2 series connected transmission lines.

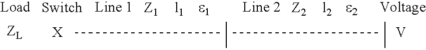

Initially, the entire transmission line, which includes line section 1 in series with line section 2, is charged to voltage V. More important however is the manner in which voltage builds up in the load after the switch closes. This analysis shows that the time of transit in line 1 (t₁) is l₁ ε₁^{1/2}/c, where c is the velocity of light. Similarly, in line 2, the time of transit (t₂) is l₂ε₂^{1/2}/c. The ratio of t₁/t₂ is l₁/l₂(ε₁/ε₂)^{1/2}=n.

Assume line 2 is a short section of high impedance line. Also, assume there are n round trips in line 2 for every round trip in line 1. Assume that Z₁<<Z_{L} and Z₂.>>Z₁.

When the logic switch (“x” in the diagram above) closes, a small step voltage wave proceeds to the right in line 1. The wave voltage is approximately V (Z₁/Z_{L}). When this wave reaches line 2, the wave that is transmitted to the right is approximately V₁=(Z₁/Z_{L})(Z₁/Z₂). The wave that is reflected at this point is nearly equal to V₁. This reflected wave travels back towards the load and raises the voltage in line 1. When this wave reaches the load, the voltage is raised by an increment.

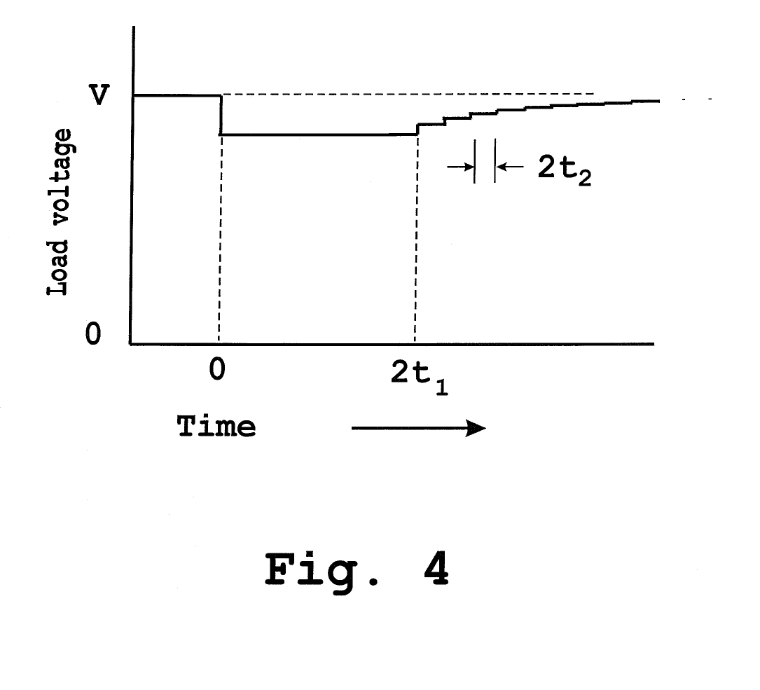

If n is a large number then the following sequence of events takes place. A wave in line 2 makes many round trips between line 1 and the voltage V while the initial wave makes one round trip in line 1. Each time the wave in line 2 makes a round trip, a small wave crosses into line 1 and moves to the left. These waves add to the voltage at the load on a delayed basis. The voltage at the load drops at the time of switch closure. After a wave makes one round trip in line 1 the load receives a series of voltage boosts from the multiple reflections in line 2. This is also illustrated in FIG. 4, which shows a plot of load voltage versus time for cascaded transmission lines, under an embodiment.

If the initial voltage drop is equated to the sum of all the voltage boosts, there is a balance in the flow of energy in the two transmission lines. The resulting equation of balance is:

(l₁/l₂)=(ε₂/ε₁)^{1/2}(Z₂/Z₁).

Because the voltage boosts follow an exponential curve, the right side of this equation should be multiplied by a factor of about 3.

In applying the above equation to a typical problem, assume l₂ is 5 millimeters (mm) in length, ε₁=3.41 (silicon), ε₂=1, Z₂=50 and Z₁=0.1. Then l₁=1.35 meters. This (l₁) is an unexpectedly large number, and this length requirement is the direct result of placing a short section of 50 ohm line (5 mm) in series with the voltage source. The conclusion is that the decoupling process should have significant length, and high capacitance and low leakage inductance are not sufficient criteria.

In comparing capacitors and transmission lines, a simple capacitor is made of two parallel conducting plates separated by a dielectric. Because of its short length it is counterintuitive to consider a capacitor a transmission line. When energy is pulled from an ideal capacitor, there is wave action. The time it takes a wave to travel the length of a capacitor depends on the dielectric constant. The time is lε^{1/2}/c where the variable 1 represents the length and c represents the velocity of light. An ideal capacitor 0.06 inches long with a dielectric constant of approximately 400 has the electrical length of an open air transmission line of 2.4 inches (the round trip time). Even if the capacitor could be made longer it is very difficult to connect the capacitor to a logic component with leads shorter than a few millimeters. From this it can be seen that an external capacitor is not a practical way to decouple an integrated circuit at clock rates in the GHz realm. Even an internal capacitor will be ineffective as it will not have an adequate path length.

A problem exists in supplying or pulling energy from any plate capacitor. If the capacitor is made from parallel conducting plates, the parallel connection blocks fields from entering the inner layers of the capacitor. Note that the same path is used to both supply and remove energy from a two-lead capacitor.

The idea of rating a capacitor in terms of its series inductance does not relate to the issue at hand. It would make much more sense to rate a capacitor in terms of its characteristic impedance and the time it takes for a step function to traverse the length of the capacitor. If the time is in picoseconds then the capacitance in pF is given by the ratio Z/t.

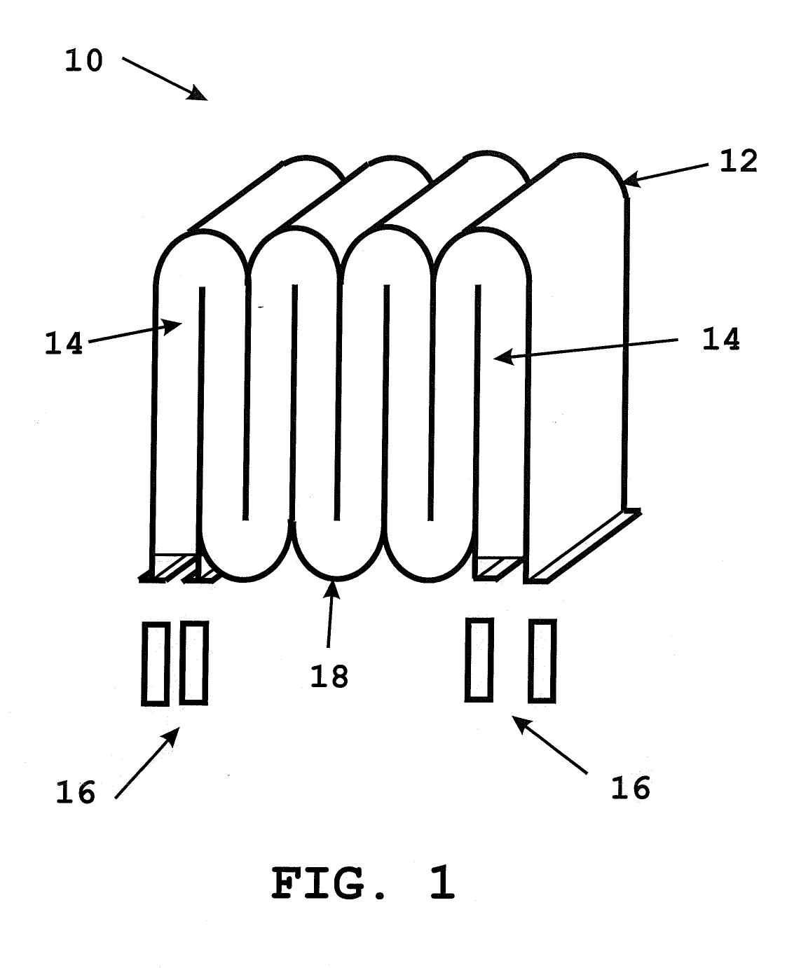

FIG. 1 is a folded transmission line capacitor 10 or device, under an embodiment. The difficulty in logic design and application is to provide the required very short low impedance connections to the capacitor. The device 10 of an embodiment provides a decoupling capacitor for use with circuits having clock rates in the GHz realm. The device 10 includes a folded transmission line rather than a group of parallel plates. This device 10, which in this embodiment is an example of a folded configuration, includes conductors 12 and 18 separated by dielectric material 14. Terminals are formed at both ends of conductors 12 and 18, and the terminals or ends of the conductors 12 and 18 correspond to the connecting pad footprints. The device of an embodiment includes four (4) terminals, but it is not necessary in operation to use all terminals. Various other examples are also possible under the teachings described herein.

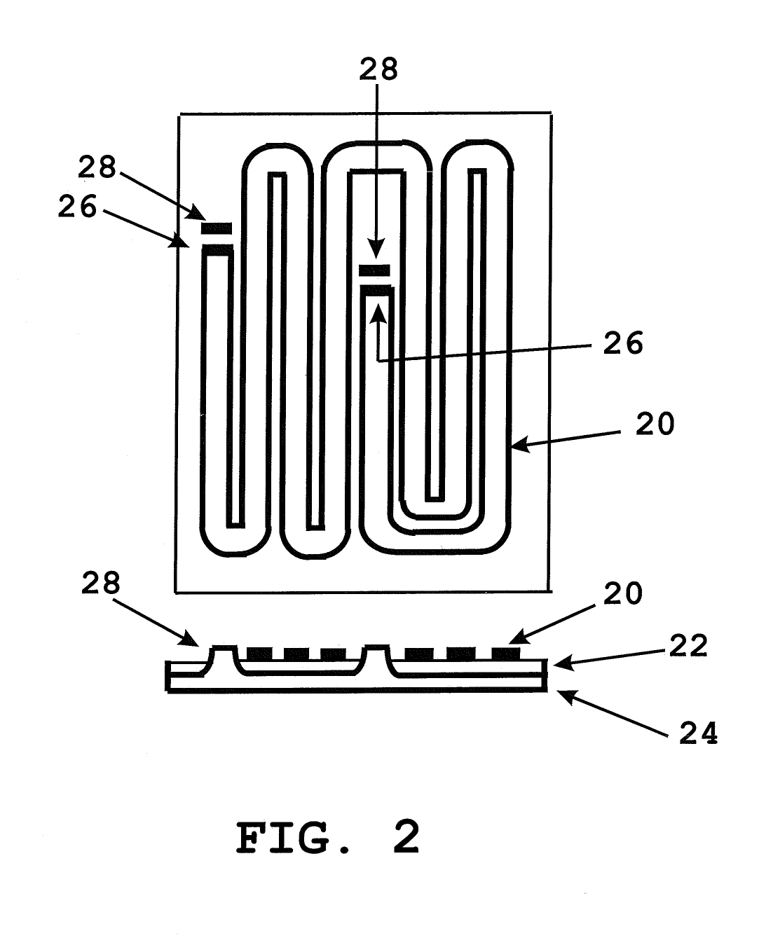

To avoid the connecting lead length problem, a die can include an integral low-impedance decoupling transmission line as described herein. FIG. 2 shows top and side views of a folded transmission line 20 on a die, under an embodiment. This transmission line 20 can be made long by forming the line using a folded transmission path, for example. If needed, the line can be formed on multiple layers. With this approach, a circuit board can use standard capacitors for decoupling, if necessary. This low impedance transmission line 20 is similar to the device 10 described above with reference to FIG. 1. This example embodiment includes a folded transmission line 20 on a die layer where conductive trace 20 is formed in a winding path separated from a conductive surface 24 by a dielectric 22 and forming a capacitor having a relatively long length. Each end of the trace 20 includes connection points 26. Nearby die contacts 28 are made to the conducting surface 24, as an example.

The device of an embodiment can be formed using doped silicon or, alternatively, a material like Barium Strontium Titanate (BST), as the dielectric, for example. This provides a larger dielectric constant and this limits the length of line required. Other suitable materials as known in the art may also be used.

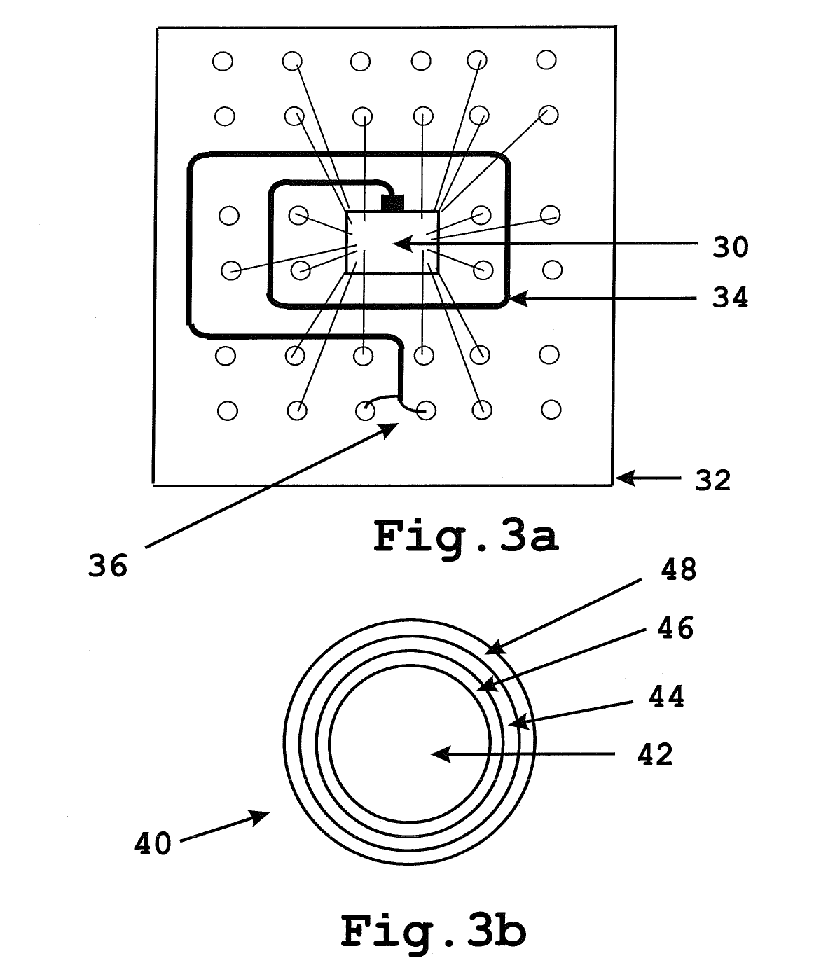

Another solution hereunder to the decoupling problem is to connect a decoupling transmission line (e.g., coax, or coaxial line or cable) directly to the die. FIG. 3A is a diagram of coaxial decoupling on a mounting structure for a die, under an embodiment. This example includes a die 30 mounted to an interposer board 32. The interposer board 32 includes various connection points, which are electrically connected to the die 30. The transmission line 34 can comprise a round copper conductor, a thin layer of deposited BST for a dielectric, and a plated outer layer of copper. The transmission line 34 is connected between the die 30 and the power supply connections 36 of the component. One example of this embodiment uses a transmission line 34 having a diameter of approximately 0.030 inches. A length of this transmission line 34 could be placed on the interposer board that mounts the die 30. In this example, the connection points 36 that correspond to power supplied to the die 30 are coupled to the die 30 using a coaxial line 34, which is routed around the interposer board 32 to achieve the desired length.

FIG. 3B is a cross sectional view of a coaxial line 40 used for coaxial decoupling on a mounting structure for a die, under an embodiment. The coaxial line 40 of an embodiment includes an inner conductor 42 and an outer conductor 44 separated by a dielectric layer 46. An outer layer of insulation 48 insulates the coaxial line 40. The coaxial line 40 of this embodiment can be used as the transmission line 34 described above with reference to FIG. 3A. Another solution is to build the decoupler transmission line as a separate die that is affixed directly to the main die.

Field energy is stored between ground and power planes on a typical circuit board. Connections to these conducting planes are typically made using vias. It is very difficult to make a connection to the two planes without introducing a section of 50 ohm (approximate) transmission line. This results in the same time delay problem described above. If the die is decoupled by the methods described herein then the energy stored in the ground/power plane can be used (power supply) and additional decoupling capacitors may not be needed on the circuit board.

The devices and methods of an embodiment include a device comprising a first electrical conductor. The device of an embodiment comprises a second electrical conductor. The device of an embodiment comprises an insulator separating the first electrical conductor from the second electrical conductor. The device of an embodiment comprises a first connector that connects the first and second electrical conductors to an electrical energy source. The device of an embodiment comprises a second connector that connects the first and second electrical conductors to an electrical load. The device of an embodiment stores and dispenses electrical energy, wherein a voltage across the electrical load is held substantially constant when the device stores the electrical energy and the electrical load is a resistive load.

The first electrical conductor of an embodiment comprises a narrow geometry relative to the second electrical conductor.

The first electrical conductor of an embodiment forms a maze on at least a side of the second electrical conductor.

The first and second electrical conductors of an embodiment are formed in a folded configuration.

The first and second electrical conductors of an embodiment are formed in a shape relative to each other, the shape selected from a group consisting of linear, stacked, and coiled.

The first and second electrical conductors of an embodiment are formed as a coaxial cable.

The first and second electrical conductors of an embodiment have a characteristic impedance of less than approximately five (5) ohms.

The voltage across the electrical load of an embodiment is held substantially constant for a predetermined time period and the second connector connects to the resistive load. The time period of an embodiment is greater than approximately 100 picoseconds.

The electrical source of an embodiment is selected from a group consisting of a power supply, a charged circuit capacitor, and a voltage between ground and power planes on a printed circuit board.

The electrical load of an embodiment is selected from a group consisting of an integrated circuit, a circuit trace on a circuit board, and a transmission line.

The first electrical conductor, the second electrical conductor, and the insulator of an embodiment comprise semiconductor material.

The first and second electrical conductors of an embodiment comprise an integral portion of an integrated circuit die. The integral portion of the integrated circuit die of an embodiment is a mounting assembly.

The first connector of an embodiment comprises a plurality of contacts with the electrical energy source.

The second connector of an embodiment comprises a plurality of contacts with the electrical load.

The first electrical conductor of an embodiment comprises a first plurality of electrical conductor pairs.

The second electrical conductor of an embodiment comprises a second plurality of electrical conductor pairs.

The devices and methods of an embodiment include a method of storing and dispensing electrical energy. The method of an embodiment comprises storing electrical energy in a device. The device of the method of an embodiment comprises first and second electrical conductors having first and second input terminals and first and second output terminals. The method of an embodiment comprises dispensing from the device stored electrical energy. The dispensing of an embodiment is at a substantially fixed rate. A length of the device and a characteristic impedance of the device of the method of an embodiment substantially eliminates time delay before the dispensing.

The method of an embodiment comprises forming the first and second electrical conductors in a configuration relative to each other. The configuration of an embodiment is selected from a group consisting of a folded configuration, a linear configuration, a stacked configuration, a coiled configuration, and a coaxial configuration.

In the preceding detailed description, embodiments of devices are described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense. Aspects of the devices described herein may be implemented in any of a variety of circuitry. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, to name a few.

It should be noted that any system, method, and/or other components disclosed herein may be described using computer aided design tools and expressed (or represented) as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description is not intended to be exhaustive or to limit the devices and methods to the precise forms disclosed. While specific embodiments of, and examples for, the devices and methods are described herein for illustrative purposes, various equivalent modifications are possible within the scope of the devices and methods, as those skilled in the relevant art will recognize. The teachings of the devices and methods provided herein can be applied to other devices and methods, not only for the devices and methods described above. The elements and acts of the various embodiments described above can be combined to provide further embodiments. These and other changes can be made to the devices and methods in light of the above detailed description.

In general, in the following claims, the terms used should not be construed to limit the embodiments to those specific embodiments disclosed in the specification and the claims, but should be construed to include all embodiments that operate under the claims. Accordingly, the embodiments are not limited by the disclosure, but instead the scope of the embodiments is to be determined entirely by the claims.

While certain aspects of the embodiments are presented below in certain claim forms, the inventor contemplates the various aspects of the embodiments in any number of claim forms. Accordingly, the inventor reserves the right to add additional claims after filing the application to pursue such additional claim forms for other aspects of the embodiments.

What is claimed is:

1. A device comprising:
a first electrical conductor;
a second electrical conductor;
an insulator separating the first electrical conductor from the second electrical conductor;
a first connector that connects the first and second electrical conductors to an electrical energy source; and
a second connector that connects the first and second electrical conductors to an electrical load;
wherein the device stores and dispenses electrical energy, wherein a voltage across the electrical load is held substantially constant when the device stores the electrical energy and the electrical load is a resistive load.

2. The device of claim 1, wherein the first electrical conductor comprises a narrow geometry relative to the second electrical conductor.

3. The device of claim 2, wherein the first electrical conductor forms a maze on at least a side of the second electrical conductor.

4. The device of claim 1, wherein the first and second electrical conductors are formed in a folded configuration.

5. The device of claim 1, wherein the first and second electrical conductors are formed in a shape relative to each other, the shape selected from a group consisting of linear, stacked, and coiled.

6. The device of claim 1, wherein the first and second electrical conductors are formed as a coaxial cable.

7. The device of claim 1, wherein the first and second electrical conductors have a characteristic impedance of less than approximately five (5) ohms.

8. The device of claim 1, wherein the voltage across the electrical load is held substantially constant for a predetermined time period and the second connector connects to the resistive load.

9. The device of claim 8, wherein the time period is greater than approximately 100 picoseconds.

10. The device of claim 1, wherein the electrical source is selected from a group consisting of a power supply, a charged circuit capacitor, and a voltage between ground and power planes on a printed circuit board.

11. The device of claim 1, wherein the electrical load is selected from a group consisting of an integrated circuit, a circuit trace on a circuit board, and a transmission line.

12. The device of claim 1, wherein the first electrical conductor, the second electrical conductor, and the insulator comprise semiconductor material.

13. The device of claim 1, wherein the first and second electrical conductors comprise an integral portion of an integrated circuit die.

14. The device of claim 13, wherein the integral portion of the integrated circuit die is a mounting assembly.

15. The device of claim 1, wherein the first connector comprises a plurality of contacts with the electrical energy source.

16. The device of claim 1, wherein the second connector comprises a plurality of contacts with the electrical load.

17. The device of claim 1, wherein the first electrical conductor comprises a first plurality of electrical conductor pairs.

18. The device of claim 1, wherein the second electrical conductor comprises a second plurality of electrical conductor pairs.

19. A method of storing and dispensing electrical energy, comprising:
storing electrical energy in a device, the device comprising first and second electrical conductors having first and second input terminals and first and second output terminals; and
dispensing from the device stored electrical energy, wherein the dispensing is at a substantially fixed rate, wherein a length of the device and a characteristic impedance of the device substantially eliminates time delay before the dispensing.

20. The method of claim 19, comprising forming the first and second electrical conductors in a configuration relative to each other, the configuration selected from a group consisting of a folded configuration, a linear configuration, a stacked configuration, a coiled configuration, and a coaxial configuration.
